SEQUENCE LISTING (1 sequence)

SEQ ID NO: 1 - DNA, 2229 bp, Bacillus subtilis
  source 1..2229: mol_type = genomic DNA
atgtcactactgcttgaaccaagtaaagaacaaataaaagaagagaaactgtatcagcaaatgggtgtcagtgatgatgagtttgcattgatagaatccattcttggaagattgccgaactacacagaaatcggaattttttctgtcatgtggtctgagcattgcagctacaaaaactcaaagccgattctgcgtaaattcccgacaagcggcgagcgtgtgctgcaggggccgggagaaggcgctggaatcgttgatatcggtgataaccaagcggttgtgttcaaaattgaatcacataaccacccatcagctatcgagccttaccaaggcgctgcgactggcgtaggcggaattatccgtgatgtattctcaatgggtgcacgtccaatcgctgtattgaactctcttcgatttggtgaactgacttcaccccgcgtgaagtacttgtttgaagaagtagtagcgggtatcgccggatacggcaactgtatcggcattcctacagtcggcggagaagtgcagtttgacagcagctatgaaggaaatccgctcgtcaacgcaatgtgcgtcggtttaatcaaccatgaagacatcaaaaaaggccaggcaaagggtgtcggcaacacagtaatgtacgtaggagcgaaaacagggcgtgacggcatccacggcgctacgtttgcttctgaagaaatgtcagactcgtctgaagaaaagcgttctgctgtccaagtcggcgatccgtttatggagaagcttttgcttgaagcatgtctggaagtcatccaatgcgacgccttagtcggcattcaggatatgggagctgccggtttaacaagctcaagtgcagaaatggcaagtaaagccggttctggcattgaaatgaaccttgacctgattcctcagcgcgaaacaggcatgaccgcgtatgaaatgatgctttctgaatcacaagaacggatgcttttggttattgagcgcggacgtgagcaggaaatcatcgatatttttgacaagtacgatcttgaagcggtttctgtcggacatgtgacagatgataaaatgcttcgcctgacacacaaaggagaggttgtgtgcgagctgcctgttgatgccttggcagaagaagcaccggtttaccataagccttctcaagagcctgcttactatcgcgagtttttggaaacggacgttccggctccgcaaattgaagatgcgaatgaaacgctgaaggcccttcttcagcagccgacgattgcgagcaaagagtgggtttacgaccagtatgactacatggtgcgcacgaatacagttgtcgctcctgggtctgatgctggtgttctcagaatccgcggaacgaaaaaggcgctggcgatgacgacagactgtaacgcgcgttatctctatcttgatcctgaagtcggcgggaaaattgctgtcgctgaagcagcgcgcaacatcatttgctcaggcgcagaaccgcttgcggtcacagataaccttaacttcggaaaccctgagaagccggaaatcttctggcagatcgaaaaagcggcagacggcataagcgaagcgtgcaatgttctcagcacaccggttattggcggtaacgtatcgctttataacgaatcaaacggcacggcgatctatccgacacctgttatcggcatggtcggcttaattgaagatacagcacacattacaacacagcatttcaaacaagcgggagatctcgtatatgtgatcggcgaaacaaaaccagagtttgccggaagcgagctgcaaaaaatgacagaaggccgtatttacggcaaagcgccgcaaatcgatcttgatgtagagctgtctcgtcaaaaagcactgcttgacgcgattaaaaaaggcctcgttcaatctgcgcatgatgtgtctgaaggcggcttaggcgtagcgattgcggaaagtgtcatgacgacggaaaaccttggcgctaatgtgactgtagaaggggaagcggcattattattctctgaatctcaatcccgcttcgtcgtttcagtgaaaaaagaacatcaagcagcgtttgaagcagctgtgaaaggtgcggttcatattggtgaggtaacggctgacggaattctggcgattcaaaaccaagacggacaacaaatgattcatgcgcaaacgaaagagcttgaacgcgtatggaaaggagctatcccatgcttgctgaaatcaaaggcttaa

(19) United States
(12) Patent Application Publication
(10) Pub. No.: US 2025/0302048 A1
(43) Pub. Date: Oct. 2, 2025

(54) Nematicidal Composition Comprising Bacillus Subtilis

(71) Applicant: CHR. HANSEN A/S, Hoersholm (DK)

(72) Inventors: Patricia Dominiguez CUEVAS, Hoersholm (DK); Deisy AMORA, Hoersholm (DK); Raquel AZEVEDO, Hoersholm (DK)

(73) Assignee: CHR. HANSEN A/S, Hoersholm (DK)

(21) Appl. No.: 18/866,400

(22) PCT Filed: May 26, 2023
(86) PCT No.: PCT/EP2023/064202

§ 371 Date: Nov. 15, 2024

(30) Foreign Application Priority Data
May 30, 2022 (EP) 22176025.9

(51) Int. Cl. A01N 63/22; A01P 5/00

(52) U.S. Cl. CPC A01N 63/22; A01P 5/00

(57) ABSTRACT

The present invention generally relates to compositions comprising Bacillus subtilis with nematicidal effect against phytonematodes on plants and/or its habitat, to its use, to a process for its preparation, to the use of Bacillus subtilis, to preventing, controlling, combating and/or conferring induction of resistance to phytonematodes and to a kit. Particularly, the invention relates to Bacillus subtilis (DSM 32324).

### FIELD OF THE INVENTION

The present invention generally relates to compositions comprising Bacillus subtilis with nematicidal effect against phytonematodes on plants and/or its habitat, to its use, to a process for its preparation, to the use of Bacillus subtilis, to preventing, controlling, combating and/or conferring induction of resistance towards phytonematodes and to a kit. Particularly, the invention relates to Bacillus subtilis (DSM 32324).

### BACKGROUND OF THE INVENTION

Intensification of agricultural activity has caused an ecological imbalance, making it necessary for use of selective products that do not affect the balance between pests and their predators, parasitoids and pathogens, responsible for much of the natural biological control, since they retain pest population levels acceptable (DENT, D., Insect pest management. Cambridge: Cabi Bioscience 2000).

In order to reverse this situation, it is recommended to develop programs for integrated pest management, defined as a decision system for the use of control tactics, singly or combined harmoniously in a management strategy based on cost/benefit that take into account the interest and/or impact on farmers, society and environment. Among the control measures available for these management systems are entomopathogenic nematodes and insect parasitoids, which cover different areas of biological pest control.

In the current context of a modern and ecologic society, which is concerned with preserving the environment, biological control is considered an attractive alternative and/or supplement to conventional methods of control. Biological control is the use of one organism (predator, parasite or pathogen) that attacks another organism which is causing economic damage to crops. This is a very common strategy in agro ecological systems, as well as in conventional agriculture which relies on the Integrated Pest Management (IPM).

Although the biological control brings positive responses in the reduction or withdrawal of pesticide use and improving farmers' income, the analysis of the set of experiments worldwide, shows that the results are still concentrated in only a few crops. There is still much to develop in areas of control of pests and diseases.

Disease caused by nematodes are very difficult to control and various methods have been tested during the past several decades, like resistant varieties, rotation with non-host crops, and application of nematicidal chemicals. However, the management tools available have low efficacy or fail to control the different nematode species commonly found in a mixture in the soil. Chemical nematicides are highly toxic compounds, which can cause severe harm to the environment after being overused. Limitations on the use of chemical pesticides have increased interest in studies on alternative methods of nematode control.

There has been a great emphasis on research on biological control with the use of bacteria colonizing the roots of plants, called rhizobacteria. The beneficial rhizobacteria for promoting growth and/or acting in the biological control of plant pathogenic bacteria are called plant growth-promoting rhizobacteria or PGPR. The PGPR increases the availability of nutrients to the plant and can produce combinations and concentrations of substances that promote growth.

The pressure of society to replace nematicides with environmental acceptable products or ecologically-friendly practices has encouraged the search for alternative methods to control nematodes. In this context, biological control has been considered one of the alternatives within an integrated approach, in which one seeks to ensure sustainable development of agriculture. The use of natural enemies has become a field of research, which may act to reduce nematode populations below the threshold level of economic damage.

The risks to humans and environment presented from using synthetic pesticides emphasize the need for tools such as biological control in optimizing sustainable agricultural systems.

European patent application EP 0705807A1 relates to a bacterial preparation for soil conditioning which comprises bacteria belonging to genus Bacillus, such as Bacillus subtilis and Bacillus licheniformis. The preparation can prevent the injuries to roots of crops caused by nematodes.

Brazilian patent application BR PI 0604602-9A relates to use of a Bacillus subtilis in conjunction with Bacillus licheniformis for control of phyto-nematodes.

Siddiqui and Mahmood (1999) describes the role of bacteria in the management of plant parasitic nematodes showing that Bacillus subtilis and Bacillus licheniformis can be useful against phytonematodes, such as Meloidogyne spp., Heterodera spp. and Rotylenchulus.

WO2012/020014 relates to a composition comprising Bacillus subtilis and Bacillus licheniformis with nematicidal effect against phytonematodes.

Sikora, R. A. (Interrelationship between plant health promoting rhizobacteria, plant parasitic nematodes and soil microorganisms. Medicine Faculty Landbouww Rijksuniv Gent, Landbouww, v.53, n.2b, p. 867-878, 1988) observed reductions in infection of Meloidogyne arenaria, M. incognita and Rotylenchulus reniformis around 60-65% with treatment of seeds of various crops with a Bacillus strain.

There is still a need for novel nematicides with higher safety and efficiency for protecting crops from nematode infestation.

The inventors of the present invention have proceeded with extensive screening and research in order to solve the object of providing biological methods of controlling nematodes based on the identification of a novel Bacillus subtilis strain, which show different nematicidal modes of action and have proven efficacy on decreasing nematode disease.

### SUMMARY OF THE INVENTION

The present invention provides a composition for use as nematicidal agent comprising as active ingredient a Bacillus subtilis having the characteristics of the strain deposited at Deutsche Sammlung von Mikroorganismen und Zellkulturen with accession No. DSM 32324 or a variant thereof, wherein the variant is obtained by using the deposited strain as starting material, and wherein the variant has retained or further improved the nematicidal properties of DSM 32324, and agrochemically acceptable excipients and/or carriers.

Compositions comprising the Bacillus subtilis of the present invention may be in the form of a wettable powder or in the form of a liquid formulation and have nematicidal effect against phytonematodes on plants and/or its habitat, thereby preventing, controlling, combating and/or conferring induction of resistance to phytonematodes.

The purpose of the studies described in the examples was to investigate the effect of DSM 32324 on nematode juvenile penetration on plant roots based on measurement of biofilm formation abilities and effect on number of gals and eggs on plant roots after nematode inoculation and administration of the composition of the invention.

The invention describe and demonstrate the benefits of the Bacillus subtilis strain DSM 32324 in improving the health of the plants to which it has been administered by demonstrating nematicidal effects.

### Definitions

In general, the terms and phrases used herein have their art-recognized meaning, which can be found by reference to standard textbooks, journal references and context known to those skilled in the art. The following definitions are provided to clarify their specific use in context of the present disclosure.

As used herein, the singular forms “a”, “an” and “the” are intended to include the plural forms as well, unless the context clearly indicates otherwise.

As used herein, the term “and/or” is intended to mean the combined (“and”) and the exclusive (“or”) use, i.e. “A and/or B” is intended to mean “A alone, or B alone, or A and B together”.

Composition: As used herein the term “composition” refers to a composition comprising a carrier and at least one bacterial strain as described herein.

Control phytonematode infections: As used herein the term “control phytonematode infections” means a method and/or composition that partly or completely inhibits phytonematode infections in a plant. Accordingly, the term “control phytonematode infections” means the phytonematode infections are reduced or completely eliminated and the overall health of the plant is improved.

Effective amount/concentration/dosage: As used herein the terms “effective amount”, “effective concentration”, or “effective dosage” are defined as the amount, concentration, or dosage of the bacterial strain(s) sufficient to improve the overall health of the plant and confer benefits similar to the ones demonstrated in the examples.

The actual effective dosage in absolute numbers depends on factors including: the state of health of the plant in question, other ingredients present. The “effective amount”, “effective concentration”, or “effective dosage” of the bacterial strains may be determined by routine assays known to those skilled in the art. An example of an effective amount is given in Examples 3 and 4.

Isolated: As used herein the term “isolated” means that the bacterial strains described herein are in a form or environment which does not occur in nature, i.e. the strain is at least partially removed from one or more or all of the naturally occurring constituents with which it is associated in nature.

Plant-parasitic nematodes: As used herein the term “plant-parasitic nematodes” means nematodes that live as parasites on plants and causes severe damage to a wide variety of crops, causing poor yield and significant financial losses annually. The word phytonematodes is intended to mean the same and phytonematodes and plant-parasitic nematodes are used interchangeable in this application. Examples of plant-parasitic nematodes includes, but are no limited to, root-knot nematodes (Meloidogyne spp.), cyst nematodes (Heterodera and Globodera spp.) and lesion nematodes (Pratylenchus spp.).

### BRIEF DESCRIPTION OF THE FIGURES

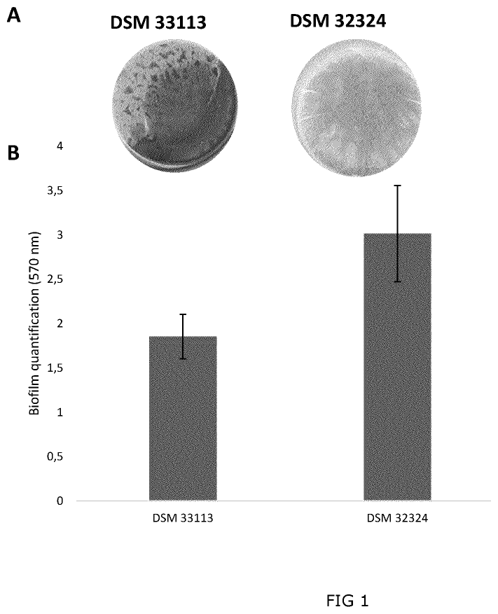

### FIG. 1

FIG. 1 discloses biofilm (pellicle) formation and quantification of DSM 33113 and DSM 32324. Spores were added to MSgg at final OD₆₀₀ 0.05 and incubated at 30° C. for 3 days in static conditions. A) Pellicle formation after 3 days incubation. B) Biofilm (pellicle) matrix quantification with crystal violet and absorbance measured at 570 nm.

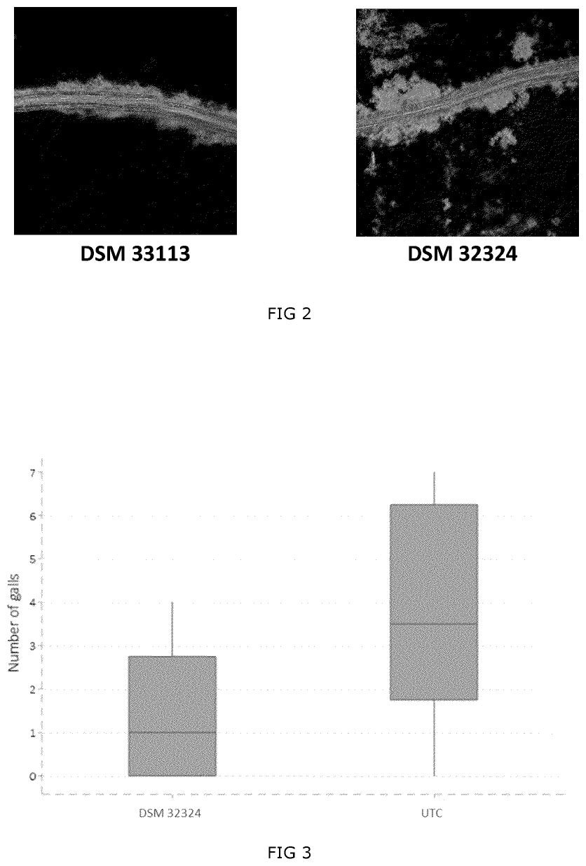

### FIG. 2

FIG. 2 discloses microscopic pictures of A. thaliana roots colonized by DSM 33113 and DSM 32324 at 24 h after inoculation. Vegetative cells were inoculated at final OD₆₀₀ 0.05 to ½ Murashigue and Skoog containing a 7-days old Arabidopsis seedling and incubated at 22° C. for 24h. Plant roots were then mounted onto an agarose pad with a coverslip on top before microscopy imaging.

### FIG. 3

FIG. 3 discloses number of galls incited by M. incognita in Arabidopsis roots seven days after plants were treated with vegetative cells of the strain DSM 32324. Plants were challenged with nematode second stage juveniles. A: Bars represent the mean of ten replicates. (p=0.07)

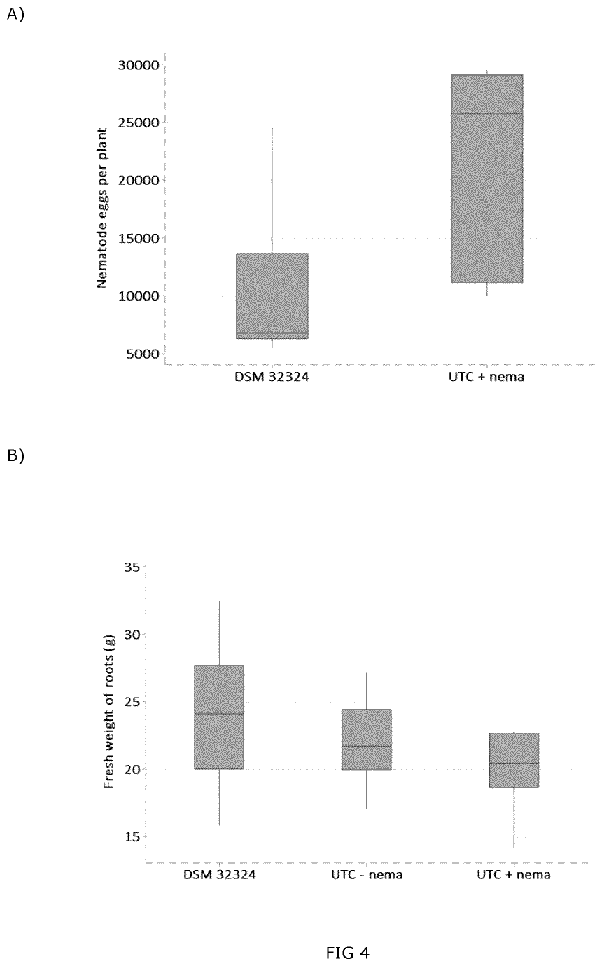

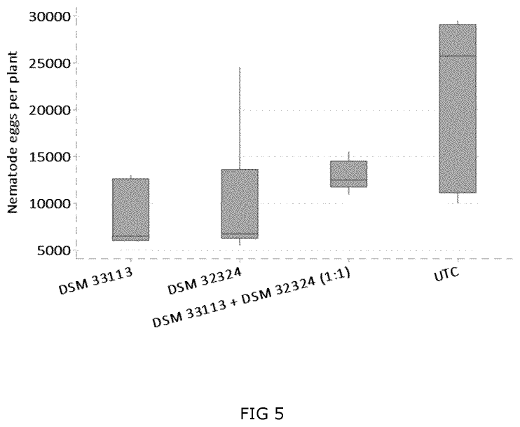

### FIG. 4

FIG. 4 discloses A) Number of eggs of M. incognita extracted from tomato roots five weeks after DSM 32324 treatment and nematode inoculation. B) Weight of fresh root of tomato plants.

### FIG. 5

FIG. 5 discloses number of eggs of M. incognita extracted from tomato roots five weeks after treatment with B. paralicheniformis DSM 33113 and B. subtilis DSM 32324 strains applied either alone or in combination and nematode inoculation.

### BRIEF DESCRIPTION OF THE SEQUENCES

### SEQ ID NO: 1

SEQ ID NO: 1 is the purL gene sequence from B. subtilis DSM32324.

### DETAILED DESCRIPTION OF THE INVENTION

### Rhizobacteria

The soils are home to a complex biological community, of which micro-organisms, prokaryotes and eukaryotes form a majority, both in number and in diversity. Some prokaryotes have ecological niches as the rhizosphere, and/or the rhizoplane of plants, where they multiply, survive and protect themselves from the antagonistic action of soil microflora. These organisms have been generically called rhizobacteria.

In association with plants, rhizobacteria may have a deleterious effect, null or beneficial. Those who exercise a beneficial effect—growth promotion and biological control of disease—are called PGPR (“Plant Growth-Promoting Rhizobacteria). It is estimated that only 0.6% of rhizobacteria have some beneficial effect for the plant with which they are associated.

PGPR have been used for biological control of plant diseases and thereby increase the productivity of crops. How and why this biological control is exercised, is still a topic that needs complementary studies.

In some situations, it is possible that biological control occurs by direct antagonism exerted by PGPR against the pathogen, with involvement of the known mechanisms of antibiosis: production of antimicrobial substances, direct parasitism, competition for nutrients and ecological niches. Research has shown that certain PGPR appear to act as elicitor of ISR (induced systemic resistance), in the sense that the plant becomes systemically protected against more than one pathogen, unlike the classical biological control, which aims to implement the control more specifically.

Some rhizobacteria produce antagonistic secondary metabolites that affect the movement of nematodes in vitro, while others inhibit the hatching of juveniles and the process by which they penetrate to the roots.

A significant parameter affecting the PGPR ability to infect and colonize the plant surface is the ability of the PGPR to form biofilm.

The present invention provides an excellent biofilm forming Bacillus strain that produces a set of secondary metabolites with nematicidal effects that have been described in the state of the art.

Rhizobacteria can inhibit plant-parasitic nematodes through different methods, both direct and indirect. Direct antagonism is based on the synthesis of lytic enzymes, toxic proteins, volatile compounds, or paratism. Indirect antagonism is expressed through competition for nutrients, inducing systemic resistance (ISR), or the release of molecules that modulate nematode behaviour including recognition, feeding and sex ratio.

The control that the rhizobacteria exert on nematodes can thus be implemented in various ways and may affect different phases of the nematode life cycle:
Egg: antibiotics and toxins produced by bacteria in the rhizosphere diffuse into the soil and can be absorbed by the eggs of the nematodes, killing cells and preventing their embryonic development.
Hatching: rhizobacteria degrade the root exudates that act as hatching factor for many species of nematodes and then there is the possibility that compounds absorbed by the nematode egg inactivate or cause deformation during development that prevent hatch.
Targeting and mobility: The transformation of root exudates into metabolic byproducts of rhizobacteria can cause the nematode simply to not recognize the chemotropic stimulus, so it would continue to move randomly, and eventually to deplete its energy reserves and die without entering the root. If the nematode recognizes the root exudates and moves towards the roots, some bacterial compounds can present nematostatic characteristics and reduce the mobility of the nematode to impede it reaching the root.
Recognition of the host: Substances produced by rhizobacteria are absorbed by roots and can alter their chemical composition, causing the nematodes not to recognize their host. It is also believed that rhizobacteria bind to lectins on the surface of roots, characterized by being the binding site between the nematode and its plant host, thereby preventing recognition.
Penetration in the root: toxin or repellant produced by rhizobacteria in high concentration in the region of the rhizoplane or in the cellular content of the epidermis of roots, can discourage the penetration of nematodes in the host plant.
Food: the rhizobacteria, or their metabolic products, can be absorbed by the plant and the latter to perceive the presence of the nematode, trigger a hypersensitive reaction in giant cells, which is the main mechanism of host resistance to nematodes of the genus Meloidogyne. This resistance, called systemic resistance, is not intrinsic to the plant, that is, a reaction that is induced in it by the presence of PGPR.
Reproduction: Some rhizobacteria have a greater effect on the reduction of eggs than in reducing the number of galls, this may be one of the operating mechanisms.

The present invention discloses a Bacillus strain which was identified to harbour a set of these qualities, making it a strong agent for the management of plant-parasitic nematodes. The main characteristics identified are, together with the ability to form a strong biofilm, the ability to synthesize surfactin, dimethyl disulphide and extracellular proteases, all secondary metabolites and enzymatic activities with proved inhibitory effect against plant-parasitic nematodes. The unique combination of these modes of action in a single microorganism has a great potential to interfere with the nematode behaviour around rhizosphere, reducing nematode penetration and its reproduction inside the plant host as shown in Example 3 and 4.

### Bacteria of the Genus Bacillus

The spore-forming rhizobacteria have a number of advantages over chemical pesticides or even on other biological control agents: they are easy to mass-produce, they are easy to store, they are adaptable to the formulation technology and require no genetic manipulation.

The spore-forming rhizobacteria can be applied by treating the substrate, immersing the seedling root systems in bacterial suspensions, watering the plant with bacterial suspension by dipping the seeds in suspension of rhizobacteria or by applying PGPR with the pelleting of seeds.

One example of a spore-forming rhizobacteria is Bacillus spp. which have drawn significant attention in recent years because of their safety to the environment and ability to deliver different modes of action for suppression of nematode population in the soil.

The Bacillus species are Gram-positive bacteria characterized by having thick cell walls and the absence of outer membranes, which differs from the Gram-negative bacteria. Much of the walls of Gram-positive bacteria is composed of peptidoglycan.

Gram-positive species are divided into groups according to their morphological and biochemical characteristics. The genus Bacillus is belonging to the group of spore-forming bacteria. Species forming spore structures that are resistant to environmental changes, sustain dry heat and certain chemical disinfectants for moderate periods of time. They persist for years on dry land.

The beneficial effect of Bacilli, such as e.g. B. subtilis, when applied near the seed or the soil, is not solely due to the antagonism afforded to pathogens. The PGPR has a positive influence on germination, development and crop yield due to the production of substances which promote plant growth (e.g. volatile organic compounds, phytohormones) and improvement in plant nutrition (e.g. solubilization of phosphorus).

Use of Bacillus spp. In the Control of Nematodes

Plant-parasitic nematodes causes severe damage to a wide range of crops worldwide, causing poor yield and significant financial losses in agricultural production. The estimated losses are around $100 billion per year worldwide in economically important crops. Root-knot nematodes (Meloidogyne spp.), cyst nematodes (Heterodera and Globodera spp.) and lesion nematodes (Pratylenchus spp.) rank at the top of the list of the most economically and scientifically important species due to their intricate relationship with the host plants, broad host range and the level of damage ensued by infection.

The use of cultivars resistant to nematodes is not always possible due to lack of resistance sources for breeding, lack of adaptability of cultivars resistant to certain regions and planting seasons, or the breakdown of resistance in field conditions. Chemical control of nematodes is generally not recommended because it is not very effective; it is expensive, because the waste it leaves in food and the environmental contamination it causes. Because of these disadvantages, there is an increased pressure from society to restrict the use of chemicals which results in a demand by farmers for products that are at the same time, non-toxic to humans and animals, cheap and very effectively control nematodes.

Many soil microorganisms are known as parasites or predators of nematodes. The action of these microorganisms can result from direct or indirect effect through interference with steps in the life cycle of the pathogen.

### Genus Meloidogyne

Nematodes of the genus Meloidogyne (root-knot nematodes) exhibit great diversity on plant hosts and occur in various regions of the globe, causing losses in different crops. The main symptom is the presence of galls on plant roots. These galls are malformations or thickening of the root system. Affected plants are poorly developed, have low production, early defoliation and premature decline, and there may occasionally be plant death, with symptoms potentiated under conditions of nutrient stress and drought.

Initially, the second stage juveniles (J2) of Meloidogyne penetrate the roots and establish a feeding site in the region of the central cylinder of roots. Through the development of the nematodes, the J2 differentiate into adult males or females. Adult males, leave the root system, and the females remain in the roots. During the development of female Meloidogyne approximately 500 eggs are laid. They are deposited in a gelatinous matrix outside the roots of which the J2 hatch, and they thereby re-infect the root system. The life cycle of root-knot nematodes are approximately four weeks and may extend under temperature conditions less favorable. Temperatures below 20° C. or above 35° C. and conditions of drought or water logging of the soil reduces the development and survival of the nematode.

The control of Meloidogyne incognita and M. javanica can be done with the use of chemicals that contain certain active ingredients such as carbofuran, etoprophos, aldicarb, metham-sodium or fenamiphos, among others, depending of the culture in question. The practice of crop rotation is also important in control due to deployment of non-host crops such as peanuts, pineapple, rice, or use plant species as ground cover also non-host such as oats.

The nematode Meloidogyne exigua is very aggressive and is very widespread in the plantations. Different methods of chemical control in areas infested by M. exigua, include the use of chemicals that contain any of the active ingredients terbufos or carbofuran, depending on the kind of culture. Among the non-host crops, stand out are cotton, peanuts, rice and oats.

Like M. exigua, M. paranaensis is widespread in coffee plantations, but is not much of a problem in other crops. As for its control, positive results has been obtained by the fungus Paecilomyces lilacinus, which reduced the nematode populations in roots of the tomato “Santa Clara” in the greenhouse.

The use of rhizobacteria in relation to biological control is already known. However, the Applicant presently developed a composition comprising Bacillus subtilis DSM 32324 or a variant thereof with nematicidal effect against phytonematodes.

Thus, the first aspect of the invention relates to the herein described novel strain or variants thereof for use as a nematicidal agent.

It is clear for the skilled person that by using the deposited strains as starting material, the skilled reader can by natural strain improvement methods or re-isolation techniques routinely obtain further variants or derivatives thereof that retain the herein described relevant features and advantages. Accordingly, the term “a variant thereof” of the first aspect relates to variant strains obtained by natural strain improvement methods using the deposited strain as starting material.

Phytonematodes and/or plant-parasitic nematodes are broadly considered any nematode having a negative impact on commercial crops. Nematodes which can be combated using the composition of the present invention include nematodes of the genus: Meloidogyne, Pratylenchus, Heterodera, Globodera, Ditylenchus, Tylenchulus, Xiphinema, Radopholus, Rotylenchulus, Helicotylenchus and Belonolaimus. Species of the genus Meloidogyne are considered of particular relevance as they are responsible for around 95% of all infestations on crops causing approximately 5% of all crop losses worldwide. The composition of the present invention may, besides the active components, contain agrochemical acceptable excipients and/or vehicles thereof. The composition of the invention further comprises agrochemically acceptable carriers, vehicles and/or adjuvants.

Agrochemically acceptable carriers, vehicles and/or adjuvants are considered to be known to the skilled reader and can be selected from the group consisting of, but not limited to maltodextrine, silicon dioxide, modified zeolite, kaolinite, lignin, starch, chitosan, and calcium carbonate. In a preferred embodiment, the agrochemically acceptable carriers, vehicles and/or adjuvants is maltodextrine and silicon dioxide.

The composition of this invention particularly serves to combat nematodes in crop plants.

In one embodiment, the composition of the present invention can be mixed with further ingredients relevant in the agrochemical field, including but not limited to a microbial, a biological, and/or a chemical insecticide, fungicide, nematicide, bactericide, herbicide, plant extract, plant growth regulator, and/or fertilizer, present in an amount suitable to benefit plant growth and/or to confer protection against a pathogenic infection in a susceptible plant, a carrier, a surfactant, a dispersant, enzyme(s) and/or a yeast extract.

Among the main crops of plants are sugar cane, coffee, soybeans, cotton, corn, potatoes, tomatoes, tobacco, banana, rice, wheat, avocado, pineapple, squash, cacao, coconut, oats, onion, lettuce, beet, carrot, cassava, beans, sunflower, pepper, turnip, apple, strawberry, okra, radish and onion.

With regard to fruitculture: citrus, grape, guava, papaya, fig, peach, plum and nespeira are of particular relevance and with regard to horticulture: eggplant and cruciferous.

With regard to floriculture: rose, chrysanthemum, lisianthus, gerbera, amaryllis, begonia and celosia.

The present invention relates to a composition comprising Bacillus subtilis DSM 32324, or a variant thereof, and to a kit comprising the composition, or prepared by the process of preparing the composition, as well as instructions and a suitable recipient.

A process for preparing a composition comprising Bacillus subtilis DSM 32324, or a variant thereof, together with agrochemically acceptable carriers, vehicles and/or adjuvants, and use of said composition for controlling, combating and/or conferring specific resistance to phytonematodes are also given.

In addition, the invention refers to the use of effective amounts of Bacillus subtilis DSM 32324, or a variant thereof, in the manufacture of an agrochemical composition with nematicidal effect against phytonematodes in a plant culture, as well as processes for controlling, combating and/or conferring specific resistance to phytonematodes.

The relevant Bacillus strains of the present invention are provided in a commercially relevant form known to the skilled person. Accordingly, in an embodiment the Bacillus strains of the composition are present in a dried (e.g. spray dried) or frozen form.

The composition of the present invention may be coated on the plant seed and can include an amount of Bacillus, such as e.g. Bacillus subtilis DSM 32324 spores, from about 1.0×10² CFU/seed to about 1.0×10⁹ CFU/seed. In another embodiment of the present invention the composition may be coated on the plant seed in an amount of Bacillus, such as e.g. Bacillus subtilis DSM 32324 spores, from about 1.0×10⁶ CFU/g of seed to about 1.0×10¹¹ CFU/g of seed.

The plant seed can include, but is not limited to, the seed of monocots and dicots, such as the seed of Cereals, Corn, Sweet Corn, Popcorn, Seed Corn, Silage Corn, Field Corn, Rice, Wheat, Barley, Sorghum, Brassica Vegetables, Broccoli, Cabbage, Cauliflower, Brussels Sprouts, Collards, Kale, Mustard Greens, Kohlrabi, Bulb Vegetables, Onion, Garlic, Shallots, Fruiting Vegetables, Pepper, Tomato, Eggplant, Ground Cherry, Tomatillo, Okra, Grape, Herbs/Spices, Cucurbit Vegetables, Cucumber, Cantaloupe, Melon, Muskmelon, Squash, Watermelon, Pumpkin, Eggplant, Leafy Vegetables, Lettuce, Celery, Spinach, Parsley, Radicchio, Legumes/Vegetables (succulent and dried beans and peas), Beans, Green beans, Snap beans, Shell beans, Soybeans, Dry Beans, Garbanzo beans, Lima beans, Peas, Chick peas, Split peas, Lentils, Oil Seed Crops, Canola, Castor, Cotton, Flax, Peanut, Rapeseed, Safflower, Sesame, Sunflower, Soybean, Root/Tuber and Corm Vegetables, Carrot, Potato, Sweet Potato, Beets, Ginger, Horseradish, Radish, Ginseng, Turnip, sugarcane, sugarbeet, Grass, or Turf grass.

In one or more embodiments, the plant seed can include seed of a drybean, a corn, a wheat, a soybean, a canola, a rice, a cotton, a grass, and a turf grass.

In an alternative embodiment, the Bacillus, or composition of present invention comprising Bacillus subtilis DSM 32324, may be added to: soil or growth medium surrounding the plant; soil or growth medium before sowing seed of the plant in the soil or growth medium; or soil or growth medium before planting the plant, the plant cutting, the plant graft, or the plant callus tissue in the soil or growth medium.

In a preferred embodiment, the Bacillus, or the composition of the present invention comprising Bacillus subtilis DSM 32324, is added to soil or growth medium surrounding the plant.

When the composition of the present invention is added to soil or growth medium surrounding the plant; soil or growth medium before sowing seed of the plant in the soil or growth medium; or soil or growth medium before planting the plant, the plant cutting, the plant graft, or the plant callus tissue in the soil or growth medium, the composition can include an amount of Bacillus, such as e.g. Bacillus subtilis DSM 32324 spores, from about 1.0×10⁶ CFU/ml to about 1.0×10⁹ CFU/ml.

In one or more embodiments, the plant, the plant cutting, the plant graft, or the plant callus tissue can include soybean, bean, snap bean, wheat, cotton, corn, pepper, tomato, potato, cassava, grape, strawberry, banana, peanut, squash, pumpkin, eggplant, sugarcane and cucumber.

The compositions including the Bacillus strain as described herein can be in the form of a liquid, an oil dispersion, a dust, a dry wettable powder, a spreadable granule, or a dry wettable granule. More specifically the composition may for example be an emulsion concentrate (EC), a suspension concentrate (SC), a suspo-emulsion (SE), a capsule suspension (CS), a water dispersible granule (WG), an emulsifiable granule (EG), a water in oil emulsion (EO), an oil in water emulsion (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a dispersible concentrate (DC), a wettable powder (WP) or any technically feasible formulation in combination with agriculturally acceptable adjuvants.

The present invention relates to a composition comprising Bacillus subtilis DSM 32324, or variants thereof, and to a kit comprising the composition, or prepared by the process of preparing the composition, as well as instructions and a suitable recipient.

A process for preparing a composition comprising Bacillus subtilis DSM 32324, or variants thereof together with agrochemically acceptable carriers, vehicles and/or adjuvants, and use of said composition for controlling, combating and/or conferring specific resistance to phytonematodes are also given.

In addition, the invention refers to the use of effective amounts of Bacillus subtilis DSM 32324, or variants thereof, in the manufacture of an agrochemical composition with nematicidal effect in a plant culture, as well as processes for promoting plant health.

In the context of the present invention, a “variant thereof” is to be understood as a Bacillus subtilis with an alteration in the wild-type nucleotides of the genome of an organism (e.g. Bacillus subtilis DSM 32324) resulting in changes in the phenotype of said organism, wherein the alteration may be a deletion of one or more nucleotides, a substitution of one or more nucleotides, an insertion of one or more nucleotides, and/or a modification of one or more nucleotides. In the context of the present invention, a deletion is to be understood as a genetic mutation resulting in the removal of one or two nucleotides of wild-type nucleotide sequence of the genome of an organism; a insertion is to be understood as the addition of one or more nucleotides to the wild-type nucleotide sequence; a substitution (or point mutation) is to be understood as a genetic mutation where a nucleotide of wild-type nucleotide sequence is changed by another nucleotide; a frameshift is to be understood as a genetic mutation caused by a insertion or deletion of a number of nucleotides in a wild-type nucleotide sequence that is not divisible by three, therefore changing the reading frame and resulting in a completely different translation from the original reading frame; an introduction of a stop codon is to be understood as a point mutation in the DNA sequence resulting in a premature stop codon; a inhibition of substrate binding of the encoded protein is to be understood as any mutation in the nucleotide sequence that leads to a change in the protein sequence responsible for preventing binding of a substrate to its catalytic site of the protein. Furthermore, a knockout mutant is to be understood as genetic mutation resulting in the removal or deletion of a gene, such as an entire gene or an entire open reading frame from the genome of an organism.

Algorithms for aligning sequences and determining the degree of sequence identity between them are well known in the art. For the purpose of the present invention and as an example, one of these algorithms is based on aligning both sequences with the blastp as provided by the National Center for Biotechnology Information (NCBI) on https://blast.ncbi.nlm.nih.gov applying standard parameter settings (Matrix: BLOSUM62, Gap Costs: Existence: 11 Extension: 1, Conditional compositional score matrix adjustment) and subsequent quantification of identical amino acid pairs in identical positions over the aligned amino acid sequences. A similar process may be carried out for aligning nucleotide sequences using, in this case, blastn as provided by the National Center for Biotechnology Information (NCBI) on https://blast.ncbi.nlm.nih.gov applying standard parameter.

In one embodiment the present invention relates to a variant of Bacillus subtilis DSM 32324, wherein the average nucleotide identity (ANI) of the Bacillus subtilis variant is at least 99%, such as e.g. at least 99.5%, such as e.g. at least 99.8%, such as e.g. at least 99.9% identical to the genome of the strain deposited at Deutsche Sammlung von Mikroorganismen und Zellkulturen with accession No. DSM 32324.

The following listed aspects are further comprised by present invention:

Aspect 1. A Bacillus subtilis expressing the purL gene, said purL gene being encoded by a sequence sharing at least 95% such as e.g. at least 96%, at least 97%, at least 98%, at least 99% sequence identity with SEQ ID NO: 1.

Aspect 2. A Bacillus subtilis according to any of the preceding aspects, wherein the genome of the strain is at least 99%, such as e.g. at least 99.5%, such as e.g. at least 99.8%, such as e.g. at least 99.9% identical to the genome of the strain deposited at Deutsche Sammlung von Mikroorganismen und Zellkulturen with accession No. DSM 32324.

Aspect 3. A Bacillus subtilis according to any of the preceding aspects producing the secondary metabolites surfactin, fengycin, dimethyl disulphide and showing extracellular protease activity.

Aspect 4. A Bacillus subtilis according to any of the preceding aspects showing a better or equal suppression of nematode disease in plants when compared to the effect of the Bacillus paralicheniformis strain deposited at Deutsche Sammlung von Mikroorganismen und Zellkulturen with accession DSM 33113 either alone or in combination with said Bacillus subtilis.

Aspect 5. A composition comprising a Bacillus subtilis according to any of the preceding aspects.

Aspect 6. A composition comprising a Bacillus subtilis according to any of the preceding aspects 1 to 5 and agrochemically acceptable excipients and/or carriers thereof.

Aspect 7. A composition comprising a Bacillus subtilis according to any of the preceding aspects 1 to 6 for use as nematicide comprising as active ingredient a Bacillus subtilis having the characteristics of the strain deposited at Deutsche Sammlung von Mikroorganismen und Zellkulturen with accession No. DSM 32324 or a variant thereof, wherein the variant is obtained by using the deposited strain as starting material, and wherein the variant has retained or further improved the nematicidal properties of DSM 32324, and agrochemically acceptable excipients and/or carriers.

Aspect 8. The composition according to any of the preceding aspects 6 to 7, wherein said agrochemically acceptable excipients and/or carriers are selected from the group consisting of maltodextrine, silicon dioxide, modified zeolite, kaolinite, lignin, starch, chitosan, and calcium carbonate.

Aspect 9. The composition according to any of the preceding aspects 5 to 8, wherein said composition is in the form of a wettable powder.

Aspect 10. The composition according to any of the preceding aspects 5 to 8, wherein said composition is in the form of a liquid formulation.

Aspect 11. The composition according to any of the preceding aspects 5 to 10, wherein said composition comprises a minimum of 1×10⁹ CFU/gram of said Bacillus subtilis.

Aspect 12. The composition according to any of the preceding aspects 5 to 11, further comprising one or a combination of a microbial, a biological, and/or a chemical insecticide, fungicide, nematicide, bactericide, herbicide, plant extract, plant growth regulator, and/or fertilizer, present in an amount suitable to benefit plant growth and/or to confer protection against a pathogenic infection in a susceptible plant, a carrier, a surfactant, a dispersant, enzyme(s) and/or a yeast extract, preferably wherein the microbial is a Bacillus strain.

Aspect 13. Use of a composition according to any of aspects 5 to 12 or a Bacillus according to any of aspects 1 to 4 as a bionematocide and/or plant growth enhancer and/or plant health promotor and/or plant disease or pest controller.

Aspect 14. Use of a composition, according to aspect 13, or a Bacillus according to any of aspects 1 to 4 for controlling, combating and/or conferring specific resistance to phytonematodes.

Aspect 15. Use according to any of aspects 13 or 14, wherein the phytonematodes are selected from the group consisting of Meloidogyne, Pratylenchus, Heterodera, Globodera, Ditylenchus, Tylenchulus, Xiphinema, Radopholus, Rotylenchulus, Helicotylenchus and Belonolaimus.

Aspect 16. Use according to any of aspects 13 to 15, wherein the phytonematode is selected from the group consisting of Meloidogyne incognita, Meloidogyne javanica, Meloidogyne exigua, Meloidogyne paranaensis, Heterodera glycines and Pratylenchus zeae.

Aspect 17. Use according to any of aspects 13 to 16 wherein the composition according to any of aspects 5 to 12 or the Bacillus according to any of aspects 1 to 4 is applied on a plant, a seed or in the habitat of a plant.

Aspect 18. Use according to aspect 17 wherein the plant is selected from the group consisting of corn, rice, sugar cane, soybean, potato, beet, carrot, coffee, tomato and banana.

Aspect 19. Process for preventing, controlling and/or combating phytonematodes on plants and/or their habitat, comprising applying an effective amount of a Bacillus of any of aspects 1 to 4 or a composition according to any of aspects 5 to 12 on plants and/or their habitat.

Aspect 20. Process for preventing, controlling and/or combating phytonematodes on plants and/or their habitat, comprising applying an effective amount of a Bacillus of any of aspects 1 to 4 or a composition according to any of aspects 5 to 12 on the phytonematodes and/or their habitat.

Aspect 21. The process of aspect 19 or 20, wherein the composition acts by lowering the infestation rate of the phytonematodes.

Aspect 22. The process of aspect 19 or 20, wherein the composition acts by reducing the penetration of the phytonematodes in the plant roots.

Aspect 23. Kit, comprising the composition as defined in any one of aspects 5 to 12, instructions for use and a suitable container.

Aspect 24. A plant seed coated with a composition according to any of aspects 5 to 12 present in an amount suitable to benefit plant growth and/or to confer protection against a pathogenic infection in a susceptible plant.

Aspect 25. The plant seed of aspect 24, wherein the composition comprises an amount of Bacillus subtilis according to any of aspects 1 to 4 spores from about 1.0×10² CFU/seed to about 1.0×10⁹ CFU/seed.

Aspect 26. The plant seed of aspect 24, wherein the composition comprises an amount of Bacillus subtilis according to any of aspects 1 to 4 spores from about 1.0×10⁶ CFU/g of seed to about 1.0×10¹¹ CFU/g of seed.

Aspect 27. The plant seed of aspect 24, wherein the composition further comprises one or a combination of a microbial, a biological, or a chemical insecticide, fungicide, nematicide, bacteriocide, or plant growth regulator present in an amount suitable to benefit plant growth and/or to confer protection against a pathogenic infection in a susceptible plant, preferably wherein the microbial is a Bacillus strain.

Aspect 28. A Bacillus according to any of the preceding aspects, wherein purL is encoded by SEQ ID NO: 1 or homologs thereof.

Aspect 29. A method of treating a plant to enhance plant growth and/or promote plant health and/or control a plant disease, wherein the method comprises the step of applying a Bacillus strain according to any of the preceding aspects 1 to 4 or the step of applying a composition according to any of the preceding aspects 5 to 12, wherein the said step leads to a similar biofilm formation or similar pellicle biofilm formation when compared to a method a) comprising a step of applying a Bacillus strain deposited at Deutsche Sammlung von Mikroorganismen und Zellkulturen with accession DSM 33113 or b) comprising a step of applying a composition having Bacillus strain deposited at Deutsche Sammlung von Mikroorganismen und Zellkulturen with accession DSM 33113.

Aspect 30. The method according to the preceding aspect 29, further comprising a step of applying a Bacillus strain according to any of the preceding aspects 1 to 4 or the composition according to any of the preceding aspects 5 to 12, to soil.

Aspect 31. The method according to any of the preceding aspects 29 to 30, wherein the step of applying a Bacillus strain according to any of the preceding aspects 1 to 4 or the composition according to any of the preceding aspects 5 to 12, is applied before, during or after the plant or plant part comes into contact with the soil.

Aspect 32. The method according to any of the preceding aspects 29 to 31, wherein the plant part is selected from the group consisting of a seed, root, corm, tuber, bulb and rhizome.

Aspect 33. Process for preparing a composition, as defined in any one of claims 1 to 4, comprising mixing, in desired ratios, effective amounts of the Bacillus subtilis for applying, together with agrochemically acceptable carriers, vehicles and/or adjuvants.

The illustrative examples presented below serve to better describe the present invention. However, the formulations described merely refer to some means to some embodiments of the present invention and should not be taken as limiting the scope thereof.

### EXAMPLES

Trials have been conducted to evaluate the nematicidal effects of the Bacillus strain of the invention both under in vitro and under greenhouse conditions.

### Example 1

### Root Colonization and Biofilm Formation:

Bacillus subtilis DSM 32324 has the capability of forming a strong biofilm on the plant roots surface. The biofilm formation was analyzed both in vitro on multiwell plates and in vivo on roots of plants. The ability of strain Bacillus subtilis DSM 32324 to form biofilm was compared to Bacillus paralicheniformis DSM 33113 strain, another rhizobacteria with ability to colonize plant roots. The ability to form biofilm under in vitro condition of Bacillus subtilis DSM 32324 was strong compared to Bacillus paralicheniformis DSM 33113 (FIG. 1). In FIG. 2 it can be seen how colonization of Bacillus subtilis DSM 32324 on the plant root in vivo was observed under microscopy and how it compares to the colonization of Bacillus paralicheniformis DSM 33113.

### Example 2

### Secondary Metabolites Production:

Along with the biofilm formation ability of the B. subtilis DSM 32324 of the invention it is relevant to investigate the production of a set of secondary metabolites which nematicidal effects has been already described in different scientific studies. The main effect of these secondary metabolites on nematodes are here described and also summarized in Table 1.

Surfactin is a cyclic lipopeptide compound with properties for inhibition of egg hatching and increase on juvenile mortality of Meloidogyne sp. (Kavitha et al., 2012). When produced by bacteria living in association with plants, surfactins and fengycins trigger the immune response of plants mediated by the induction of hydroperoxides and lipoxygenase (Ongena et al., 2007).

Dimethyl disulphide can reduce the mobility of M. incognita juveniles, the gall incidence and nematode reproduction (Bui & Desaeger, 2021). Dimethyl disulphide is considered as one of the main volatile organic compounds (VOCs) with nematicidal properties and its use has been explored as fumigant (Yin et al., 2021).

B. subtilis DSM 32324 also shows extracellular protease activity, that is widely distributed in Bacillus strains with nematicidal activity suggesting that these enzymes likely play an important role in bacteria-nematode-plant-environment interactions and that they may serve as important nematicidal factors in balancing nematode populations in the soil (Lian et al., 2007). The main role is linked to degradation of nematodes cuticle.

The B. subtilis DSM 32324 strain furthermore harbors the gene purL (99% of identity) that has been identified as the responsible gene for mediating nematicidal activity against different plant parasitic nematodes as Ditylenchus destructor, Bursaphelenchus xylophilus and Meloidogyne javanica (Xia et al., 2011).

TABLE 1
List of B. subtilis DSM 32324 metabolites and enzymatic activities
with bionematicide activity and relevant described mechanisms.

| Bioactive metabolite or | DSM | |
|---|---|---|
| enzymatic ectivity | 32324 | Described mechanism (reference) |
| Other volatile compounds | +++ | Several volatile compounds have been shown |
| (i.e. Dimethyl disulfide | | to either reduce nematodes movement or |
| (DMDS), decanal, | | have nematicidal effects (Gu et al., 2007) |
| nonanone, | | DMDS shows nematicide activity by inducing |
| methylbenzene, | | oxidative stress on the nematodes (Bui & |
| undecanone etc) | | Desaeger, 2021 and Yin et al., 2021) |
| Fengycin LP family | +++ | Trigger induced systemic resistance (ISR), |
| | | which protect plants against attacks of |
| | | pathogenic microbes, viruses and nematodes |
| | | (Ongena et al., 2007) |
| Surfactin LP family | +++ | Trigger induced systemic resistance (ISR), |
| | | which protect plants against attacks of |
| | | pathogenic microbes, viruses and nematodes |
| | | (Ongena et al., 2007) |
| Protease activity | +++ | Cuticle-degrading proteases produced by |
| | | Bacillus strains showed nematicidl activity |
| | | (Lian et al., 2007) |
| Purine biosynthesis | OK | Production of purine biosynthesis |
| pathway (i.e. purL gene) | | intermediates is important to maintain |
| | | nematicide activity (Xia et al., 2011) |

+ means enzymatic activity or metabolite produce in low concentration, ++ means enzymatic activity or metabolite produce in medium concentration, and +++ means enzymatic activity or metabolite produce in high concentration compared with well described Bacillus subtilis strains.

### Example 3

### Nematode Disease Suppression:

The suppression of nematodes in plants was evaluated under two different conditions. In the first experiment, Arabidopsis roots were treated with vegetative cells of DSM32324 that were then inoculated with juveniles of M. incognita. The aim of the experiment was to measure the ability of the bacteria to reduce the penetration of the nematode in the roots compared to non-treated roots. Bacillus subtilis DSM 32324 reduces the penetration of the nematode in the plant, suggesting that the ability of the strain to form strong biofilm and its ability to produce metabolites is aiding in protecting the roots from penetration of nematodes and thus nematode infection (FIG. 3).

A second experiment was carried out under greenhouse conditions. One tomato seedling, two weeks old, was transferred to each pot, and the area around the stem was drenched with 50 ml of DSM 32324 spore suspension at a concentration of 106 spores/ml. Each plant was inoculated with 3000 eggs of M. incognita through two holes around the stem. Plants were kept under greenhouse conditions, 26° C., for five weeks. For evaluation of the experiment, roots were uplifted, cleaned, weighed, and taken for nematode extractions. Plants treated with DSM 32324 had lower infestation and more developed roots than untreated roots (FIG. 4).

### Example 4

A greenhouse experiment was set to evaluate the efficacy of the B. paralicheniformis DSM 33113 and B. subtilis DSM 32324 strains on nematode control when applied alone or in combination. Tomato seedlings (Solanum lycopersicum variant ‘Tiny Tim’), two weeks old, was transferred to pots filled with two liters of non-sterile soil (one seedling per pot). After transplanting the seedling, the area around the plant stem was drenched with 50 ml of each treatment. The treatments consisted of spores suspended in water at the concentration of 106 spores/ml. After being treated with the bacteria, each plant was inoculated with 3000 eggs of M. incognita through two holes around the stem. The plants were kept under greenhouse conditions, 26° C., for five weeks. For evaluation of the experiment, roots were uplifted, cleaned, weighed, and taken for extraction of the nematode eggs. The number of eggs were used as a parameter for nematode development inside the tomato roots. The experiment was set in completely randomized design with nine biological replicates per treatments. Data was submitted to ANOVA followed by Tukey's test grouping.

### CONCLUSION

The strains DSM 32324 has the ability to prevent nematode juvenile penetration on host roots and therefore decrease nematode development inside the plants. Due to the different nematicidal mode of actions demonstrated for DSM 32324 and its proven efficacy on decreasing nematode disease, this strain has the potential to fulfil a lack of a good tool for controlling different plant-parasitic nematode species.

### Deposit and Expert Solution

The applicant requests that a sample of the deposited microorganisms stated below may only be made available to an expert, subject to available provisions governed by Industrial Property Offices of States Party to the Budapest Treaty, until the date on which the patent is granted.

TABLE 2
Deposits made at a Depositary institution having acquired the
status of international depositary authority under the Budapest
Treaty on the International Recognition of the Deposit of
Microorganisms for the Purposes of Patent Procedure: Leibniz
Institute DSMZ-German Collection of Microorganisms and Cell
Cultures Inhoffenstr. 7B, 38124 Braunschweig, Germany.

| Strain | Accession No. | Deposit date (D.M.Y) |
|---|---|---|
| Bacillus subtilis | DSM 32324 | 8 Jun. 2016 |

### Sequences

Forming part of present description is the sequence listing attached hereto.

As specified therein, the sequences

SEQ ID NO: 1 is the purL gene sequence from B. subtilis DSM32324

ATGTCACTAC TGCTTGAACC AAGTAAAGAA CAAATAAAAG
AAGAGAAACT GTATCAGCAA ATGGGTGTCA GTGATGATGA
GTTTGCATTG ATAGAATCCA TTCTTGGAAG ATTGCCGAAC
TACACAGAAA TCGGAATTTT TTCTGTCATG TGGTCTGAGC
ATTGCAGCTA CAAAAACTCA AAGCCGATTC TGCGTAAATT
CCCGACAAGC GGCGAGCGTG TGCTGCAGGG GCCGGGAGAA
GGCGCTGGAA TCGTTGATAT CGGTGATAAC CAAGCGGTTG
TGTTCAAAAT TGAATCACAT AACCACCCAT CAGCTATCGA
GCCTTACCAA GGCGCTGCGA CTGGCGTAGG CGGAATTATC
CGTGATGTAT TCTCAATGGG TGCACGTCCA ATCGCTGTAT
TGAACTCTCT TCGATTTGGT GAACTGACTT CACCCCGCGT
GAAGTACTTG TTTGAAGAAG TAGTAGCGGG TATCGCCGGA
TACGGCAACT GTATCGGCAT TCCTACAGTC GGCGGAGAAG
TGCAGTTTGA CAGCAGCTAT GAAGGAAATC CGCTCGTCAA
CGCAATGTGC GTCGGTTTAA TCAACCATGA AGACATCAAA
AAAGGCCAGG CAAAGGGTGT CGGCAACACA GTAATGTACG
TAGGAGCGAA AACAGGGCGT GACGGCATCC ACGGCGCTAC
GTTTGCTTCT GAAGAAATGT CAGACTCGTC TGAAGAAAAG
CGTTCTGCTG TCCAAGTCGG CGATCCGTTT ATGGAGAAGC
TTTTGCTTGA AGCATGTCTG GAAGTCATCC AATGCGACGC
CTTAGTCGGC ATTCAGGATA TGGGAGCTGC CGGTTTAACA
AGCTCAAGTG CAGAAATGGC AAGTAAAGCC GGTTCTGGCA
TTGAAATGAA CCTTGACCTG ATTCCTCAGC GCGAAACAGG
CATGACCGCG TATGAAATGA TGCTTTCTGA ATCACAAGAA
CGGATGCTTT TGGTTATTGA GCGCGGACGT GAGCAGGAAA
TCATCGATAT TTTTGACAAG TACGATCTTG AAGCGGTTTC
TGTCGGACAT GTGACAGATG ATAAAATGCT TCGCCTGACA
CACAAAGGAG AGGTTGTGTG CGAGCTGCCT GTTGATGCCT
TGGCAGAAGA AGCACCGGTT TACCATAAGC CTTCTCAAGA
GCCTGCTTAC TATCGCGAGT TTTTGGAAAC GGACGTTCCG
GCTCCGCAAA TTGAAGATGC GAATGAAACG CTGAAGGCCC
TTCTTCAGCA GCCGACGATT GCGAGCAAAG AGTGGGTTTA
CGACCAGTAT GACTACATGG TGCGCACGAA TACAGTTGTC
GCTCCTGGGT CTGATGCTGG TGTTCTCAGA ATCCGCGGAA
CGAAAAAGGC GCTGGCGATG ACGACAGACT GTAACGCGCG
TTATCTCTAT CTTGATCCTG AAGTCGGCGG GAAAATTGCT
GTCGCTGAAG CAGCGCGCAA CATCATTTGC TCAGGCGCAG
AACCGCTTGC GGTCACAGAT AACCTTAACT TCGGAAACCC
TGAGAAGCCG GAAATCTTCT GGCAGATCGA AAAAGCGGCA
GACGGCATAA GCGAAGCGTG CAATGTTCTC AGCACACCGG
TTATTGGCGG TAACGTATCG CTTTATAACG AATCAAACGG
CACGGCGATC TATCCGACAC CTGTTATCGG CATGGTCGGC
TTAATTGAAG ATACAGCACA CATTACAACA CAGCATTTCA
AACAAGCGGG AGATCTCGTA TATGTGATCG GCGAAACAAA
ACCAGAGTTT GCCGGAAGCG AGCTGCAAAA AATGACAGAA
GGCCGTATTT ACGGCAAAGC GCCGCAAATC GATCTTGATG
TAGAGCTGTC TCGTCAAAAA GCACTGCTTG ACGCGATTAA
AAAAGGCCTC GTTCAATCTG CGCATGATGT GTCTGAAGGC
GGCTTAGGCG TAGCGATTGC GGAAAGTGTC ATGACGACGG
AAAACCTTGG CGCTAATGTG ACTGTAGAAG GGGAAGCGGC
ATTATTATTC TCTGAATCTC AATCCCGCTT CGTCGTTTCA
GTGAAAAAAG AACATCAAGC AGCGTTTGAA GCAGCTGTGA
AAGGTGCGGT TCATATTGGT GAGGTAACGG CTGACGGAAT
TCTGGCGATT CAAAACCAAG ACGGACAACA AATGATTCAT
GCGCAAACGA AAGAGCTTGA ACGCGTATGG AAAGGAGCTA
TCCCATGCTT GCTGAAATCA AAGGCTTAA

### REFERENCES

Dent, D. (2000) Insect pest management. Cambridge: Cabi Bioscience
Sikora, R. A. (1988). Interrelationship between plant health promoting rhizobacteria, plant parasitic nematodes and soil microorganisms. Medicine Faculty Landbouww Rijksuniv Gent, Landbouww, v.53, n.2b, p. 867-878
Gu, Y. Q., Mo, M. H., Zhou, J. P., Zou, C. S., & Zhang, K. Q. (2007). Evaluation and identification of potential organic nematicidal volatiles from soil bacteria. Soil Biology and Biochemistry, 39 (10), 2567-2575. https://doi.org/10.1016/J.SOILBIO.2007.05.011
Ongena, M., Jourdan, E., Adam, A., Paquot, M., Brans, A., Joris, B., Arpigny, J. L., & Thonart, P. (2007). Surfactin and fengycin lipopeptides of Bacillus subtilis as elicitors of induced systemic resistance in plants. Environmental Microbiology, 9 (4), 1084-1090. https://doi.org/10.1111/j.1462-2920.2006.01202.x
Lian, L. H., Tian, B. Y., Xiong, R., Zhu, M. Z., Xu, J., & Zhang, K. Q. (2007). Proteases from Bacillus: a new insight into the mechanism of action for rhizobacterial suppression of nematode populations. Letters in Applied Microbiology, 45 (3), 262-269. https://doi.org/10.1111/j.1472-765X.2007.02184.x
Xia, Y., Xie, S., Ma, X., Wu, H., Wang, X., & Gao, X. (2011). The purL gene of Bacillus subtilis is associated with nematicidal activity. FEMS Microbiology Letters, 322 (2), 99-107. https://doi.org/10.1111/j.1574-6968.2011.02336.x
Yin, N., Liu, R., Zhao, J.-L., Khan, R. A. A., Li, Y., Ling, J., Liu, W., Yang, Y.-H., Xie, B.-Y., & Mao, Z.-C. (2021). Volatile Organic Compounds of Bacillus cereus Strain Bc-cm103 Exhibit Fumigation Activity against Meloidogyne incognita. Plant Disease, 105 (4), 904-911. https://doi.org/10.1094/PDIS-04-20-0783-RE
Bui, H. X., & Desaeger, J. A. (2021). Volatile compounds as potential bio-fumigants against plant-parasitic nematodes-a mini review. Journal of Nematology, 53, 1-12. https://doi.org/10.21307/jofnem-2021-014
Kavitha, P. G., Jonathan, E. I., & Nakkeeran, S. (2012). Effects of crude antibiotic of Bacillus subtilis on hatching of eggs and mortality of juveniles of Meloidogyne incognita. Nematologia Mediterranea, 40, 203-206.
Z. A. Siddiqui, I. Mahmood. (1999). Role of bacteria in the management of plant parasitic nematodes: A review. Bioresource Technology, 69 (2), 167-179. https://doi.org/10.1016/S0960-8524 (98) 00122-9.

1-15. (canceled)

16. A method comprising introducing Bacillus subtilis DSM 32324 into a plant growth medium.

17. The method of claim 16, wherein said Bacillus subtilis DSM 32324 is introduced into said plant growth medium in an amount sufficient to suppress nematode infestation of a plant grown therein, as compared to a corresponding control plant grown in a corresponding control soil into which Bacillus subtilis DSM 32324 is not introduced.

18. The method of claim 16, wherein said Bacillus subtilis DSM 32324 is introduced into said plant growth medium in an amount sufficient to enhance at least one growth parameter of a plant grown therein, as compared to a corresponding control plant grown in a corresponding control soil into which Bacillus subtilis DSM 32324 is not introduced.

19. The method of claim 16, wherein said Bacillus subtilis DSM 32324 is introduced into said plant growth medium in an amount sufficient to enhance root growth of a plant grown therein, as compared to a corresponding control plant grown in a corresponding control soil into which Bacillus subtilis DSM 32324 is not introduced.

20. The method of claim 16, wherein said Bacillus subtilis DSM 32324 is introduced into said plant growth medium as part of a composition comprising at least 1×106 colony-forming units (CFU) of said Bacillus subtilis DSM 32324 per gram of said composition.

21. The method of claim 16, wherein said Bacillus subtilis DSM 32324 is introduced into said plant growth medium as part of a plant whose roots have been treated with said Bacillus subtilis DSM 32324.

22. The method of claim 16, wherein said Bacillus subtilis DSM 32324 is introduced into said plant growth medium as part of a composition comprising a plant seed that is at least partially coated with said Bacillus subtilis DSM 32324.

23. The method of claim 22, wherein said composition comprises at least 1×102 colony-forming units (CFU) per plant seed.

24. A kit comprising a plant seed that is at least partially coated with a composition comprising Bacillus subtilis DSM 32324 and instructions for introducing said seed into a plant growth medium.

25. A method comprising applying Bacillus subtilis DSM 32324 to a plant or plant part.

26. The method of claim 25, wherein said Bacillus subtilis DSM 32324 is applied to said plant or plant part in an amount sufficient to suppress nematode infestation of said plant or plant part, as compared to a corresponding control plant or plant part to which Bacillus subtilis DSM 32324 is not applied.

27. The method of claim 25, wherein said Bacillus subtilis DSM 32324 is applied to said plant or plant part in an amount sufficient to enhance at least one growth parameter of of said plant or plant part, as compared to a corresponding control plant or plant part to which Bacillus subtilis DSM 32324 is not applied.

28. The method of claim 25, wherein said Bacillus subtilis DSM 32324 is applied to said plant or plant part in an amount sufficient to enhance root growth of of said plant or plant part, as compared to a corresponding control plant or plant part to which Bacillus subtilis DSM 32324 is not applied.

29. The method of claim 25, wherein said Bacillus subtilis DSM 32324 is applied to said plant or plant part as part of a composition comprising at least 1×106 colony-forming units (CFU) of said Bacillus subtilis DSM 32324 per gram of said composition.

30. The method of claim 25, wherein said Bacillus subtilis DSM 32324 is applied to a plant seed.
